(19) United States
(12) Patent Application Publication
(10) Pub. No.: US 2009/0002257 A1
(43) Pub. Date: Jan. 1, 2009

(54) PRECISION FLEXIBLE SUPPORT STRUCTURE

(75) Inventors: Maxim de Jong, Chilliwack (CA); Brian Aiken, Las Vegas, NV (US)

Correspondence Address: SCHWEGMAN, LUNDBERG & WOESSNER, P.A., P.O. BOX 2938, MINNEAPOLIS, MN, 55402, US

(73) Assignee: Thin Red Line Aerospace Ltd., Chilliwack (CA)

(21) Appl. No.: 12/123,883

(22) Filed: May 20, 2008

Related U.S. Application Data
(60) Provisional application No. 60/939,531, filed on May 22, 2007.

(51) Int. Cl. H01Q 1/42; B64G 1/00

(52) U.S. Cl. 343/872; 244/158.3

(57) ABSTRACT

This document discloses, among other things, an inflatable apparatus having a plurality of attachment points. The apparatus can be collapsed, and when distended, the attachment points are dimensionally stable with varying applied pressure.

### CLAIM OF PRIORITY

This document claims the benefit of priority, under 35 U.S.C. § 119(e), to Maxim de Jong et al, U.S. Provisional Patent Application Ser. No. 60/939,531, entitled “PRECISION FLEXIBLE SUPPORT STRUCTURE,” filed on May 22, 2007 (Attorney Docket No. 001 956.004PRV), and is incorporated herein by reference.

### CROSS-REFERENCE TO RELATED PATENT DOCUMENTS

This document is also related to US patent application entitled FLEXIBLE VESSEL, filed Aug. 9, 2006, Ser. No. 11/463,560, inventor de Jong, and is incorporated herein by reference.

### TECHNICAL FIELD

The present subject matter relates generally to a flexible vessel structure that provides geometrically precise structural support or protection along with high specific strength and robust construction. In one example, the present subject matter can be collapsed to occupy a relatively small volume, and can be distended to present a relatively large size. One example of the present subject matter provides a precision support or protective structure for antenna architecture destined for deployment in a remote terrestrial, atmospheric, or space environment.

### BACKGROUND

For certain payloads used with space vehicles, dimensional stability of a structure affects performance. For example, the performance of a radio antenna is affected by the rigidity with which the antenna is mounted.

Current structures used in space vehicles are inadequate.

### OVERVIEW

Demand for high-performance flexible structure technology continues to drive polymer science and associated manufacturing capability at a vigorous pace. Performance is measured across a set of desirable attributes which differ in priority depending on the technology's intended application. Two commonly identified primary performance attributes for polymer-based architecture are robust flexibility and high specific strength. A flexible structure can take advantage of the inherent tensile stability of its flexible components with the conspicuous benefit, amongst others, of potential collapsibility for transport and superior specific strength. The benefits derived from flexible architecture become more significant when application is considered in remote locations, whether on earth, in the atmosphere, or in operational environments of diminished gravitational force such as the vacuum of space.

Projects deployed in remote areas or harsh environments are increasingly reliant upon flexible structure technology to the extent that many such projects would otherwise be unfeasible. Certain of these projects are particularly challenging in that, besides seeking flexible deployability or extremely large size, these structures simultaneously rely on considerable geometric precision or predictability for proper functioning. Highly definite geometry is not an attribute commonly associated with material flexibility. An example of such a structure is a space-based antenna: greater size offers greater benefit, primarily in observational resolution. Therefore it would be beneficial if a very large, flexible, deployable antenna with support structure can be launched in its collapsed configuration to a destination in space where the integrated structure is subsequently deployed to full size. Besides providing a solution to the quest for large dimension, such a system offers the attraction of reduced launch cost due to smaller launch vehicle requirements and reduced payload fairing dimensions.

A vessel includes a substantially impervious barrier membrane structure confined by a restraint structure including a meridional array of tendons disposed between and connecting two polar end structures. The barrier is prepared sufficiently oversized with respect to the global geometry of the vessel's restraining tendon structure that the barrier material bulges outwards between restraint tendons to form meridional lobes with sufficient excess material to substantially preclude loading of the barrier structure in its meridional sense. Since membrane stress is proportional to the radius of the distended membrane, rather than carrying any of the vessel's global membrane stress the barrier is subjected only to the local pressure-induced stress corresponding to the relatively small radius of the barrier material bulges between adjacent tendons. Lacking a circumferential restraint structure the vessel assumes a particular natural shape geometry resembling an oblate spheroid. In one example, the vessel's global pressure confining load is carried by the meridional array of restraint structure tendons, and the strength requirement of the barrier structure remains independent of overall vessel size.

The present subject matter provides statically determinate global stress distribution allowing the geometry of the surface of revolution defined by the array of tendons to be accurately predicted. This geometric predictability allows the present subject matter, upon pressurization, to be used as precision support architecture for equipment and devices. In one example, an antenna reflector is positioned within the interior of the present subject matter, whereby the tendons serve as geometry-defining anchorage for a web of reflector-shaping load ribs. Geometry-defining components of the structure, such as the aforementioned web of load ribs, may be constructed from materials which rigidize in the environment in which the structure is deployed. As such, the structural geometry is safeguarded in case of depressurization of the vessel. Such incorporation of rigidizable materials is particularly applicable to orbital space environments whereby orbital debris may puncture the vessel.

Each polar end structure of the vessel may be rigid or flexible. Without compromise in strength, the vessel can be manufactured as a fully functional embodiment without incorporation of any significant rigid components such as rigid end structures or internal core thereby further broadening the vessel's potential range of application, as well as having greater compressibility, lighter weight, greater robustness, and reduced cost.

An example embodiment of an individual flexible end structure of the vessel's restraint structure comprises one or more lengths of high modulus cordage to be threaded through the eyes of one polar end of each of all the restraint tendons. The ends of the end structure cordage are fastened to one another to form a ring structure to which the tendons are structurally connected. An individual length of such cordage may be passed through the aforementioned eyes more than once to minimize quantity or bulk of fastened connections. Larger vessels and higher pressure loads may favor incorporation of several such ring structures positioned concentrically to serve as a single polar end structure to allow staggered attachment of tendons to suitably accommodate increased tendon convergence bulk.

Conversely, the present subject matter may incorporate a rigid end structure at one or both vessel poles to which the vessel's tendons are structurally attached by common methods. If configurationally permitted, the present vessel's end structure may be prepared with a flexible end structure of adequately large aperture to allow its fitment to the mating structure. In general, the flexible end structure allows great versatility and facilitates significant opportunity for the vessel's modular combination with, or integration into, other architecture.

The present subject matter provides a barrier structure which, in one example, serves as the vessel's substantially impervious barrier membrane for the containment of pressurized fluid interior to the membrane. The barrier structure may comprise one or more high-modulus structural carrier layers confining one or more substantially impervious bladder layers. A connection system of sufficient strength to maintain its integrity throughout the vessel's operational parameters is provided to accurately index the barrier structure to the inside of the vessel's meridional array of restraint tendons and to allow modular assembly of the aforementioned components.

In an example embodiment, the present subject matter includes a method of manufacture for the barrier structure whereby two substantially planar circles of barrier structure material are sealingly connected to one another along their edges whereby the three dimensional ‘natural shape’ is effectively derived from the pressurization of this simple two dimensional barrier structure. With the subsequent connection of a suitably undersized restraint structure to the barrier structure, excess barrier structure material presented upon the vessel's pressurization is restructured into an array of lobes bulging outwards between the members of the corresponding array of restraint tendons thereby facilitating the beneficial stress distribution described earlier. One example of the present subject matter provides simple, modular vessel assembly.

In one example configured for an internal structural core, the present subject matter includes a vessel having an elongate internal core disposed lengthwise between and connected to the two polar end structures. This internal core may also be telescopic in nature, whereby the shortened core may be chosen to correspond to the distended, deployed configuration of the vessel's flexible shell, and whereby the core, when extended, may be chosen to push the end structures apart allowing the shell to collapse and align itself with the core. Further benefits of a structural core are dependent upon application of the vessel but may include structural integrity for transport packaging, to safeguard against rocket launch-induced stress, or housing for services and controls. In the case of an antenna reflector located within the interior of the present subject matter, the core may serve as a support mast for the antenna's feed hardware.

This overview is intended to provide an overview of present subject matter. It is not intended to provide an exclusive or exhaustive explanation of the invention. The detailed description is included to provide further information about the present subject matter.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a partial cut-away perspective view of a vessel used to support and protect an antenna reflector.

FIG. 2 is an isometric view of the vessel with flexible polar end structures according to an example embodiment.

FIG. 3 is a schematic cut-away perspective view showing the surface of revolution geometry of the vessel according to an example embodiment.

FIG. 4 is an isometric view of the vessel's restraint structure with flexible end structures, according to an example embodiment.

FIGS. 5, 6 and 7 are isometric views illustrating a procedure to develop the geometry of the vessel according to an example embodiment.

FIG. 8 is a partial detail view of the vessel's array of restraint structure tendons fastened to a flexible polar end structure comprising one end structure ring according to an example embodiment.

FIG. 9 is a partial detail view of the vessel's tendon array fastened to a flexible polar end-structure comprising two end structure rings according to an example embodiment.

FIG. 10 is a partial cut-away view showing a suitable method for fastening restraint tendons to a rigid polar end structure according to an example embodiment.

FIG. 11 is an isometric detail view of a method for fastening an indexing tab to a restraint tendon according to an example embodiment.

FIG. 12 is an isometric detail view of a method for locally fastening a restraint tendon to the vessel's barrier structure according to an example embodiment.

FIG. 13 is a simplified perspective view of the two component circles of barrier structure material prepared for assembly of the vessel's barrier structure according to an example embodiment.

FIG. 14 is a partial perspective view of two restraint tendons fastened to the vessel's barrier structure according to an example embodiment.

FIG. 15 is a cut-away view of a vessel with rigid polar end structures and telescopic core, showing the vessel in its collapsed configuration positioned within a rocket payload fairing according to an example embodiment.

FIG. 16 is a cut-away view of the vessel shown in FIG. 15, showing the vessel's end structures and telescopic core corresponding to the vessel's collapsed configuration positioned within a rocket payload fairing according to an example embodiment.

FIG. 17 is a simplified partial cut-away view of the vessel in its deployed configuration according to an example embodiment.

### DETAILED DESCRIPTION

In the following detailed description of the example embodiments, reference is made to the accompanying drawings that form a part hereof, and in which are shown by way of illustrating specific example embodiments. The example embodiments illustrated are described in sufficient detail to enable those skilled in the art to practice the teachings disclosed herein. Other example embodiments can be utilized and derived there from, such that structural and logical substitutions and changes can be made without departing from the scope of the claims. The following detailed description, therefore, is not to be taken in a limiting sense, and the scope of various embodiments is defined only by the appended claims, along with the full range of equivalents to which such claims are entitled.

The example embodiments described below are illustrative of multidisciplinary technology where highly complex devices are required to perform with the utmost reliability in a great variety of circumstances and environments and hence draw upon a multitude of different arts. The successful manufacture of these various example embodiments, particularly for space applications, is reliant upon skills from different arts including mechanical engineering, pressure vessel construction, technical fabric sewing and polymer film sealing and bonding.

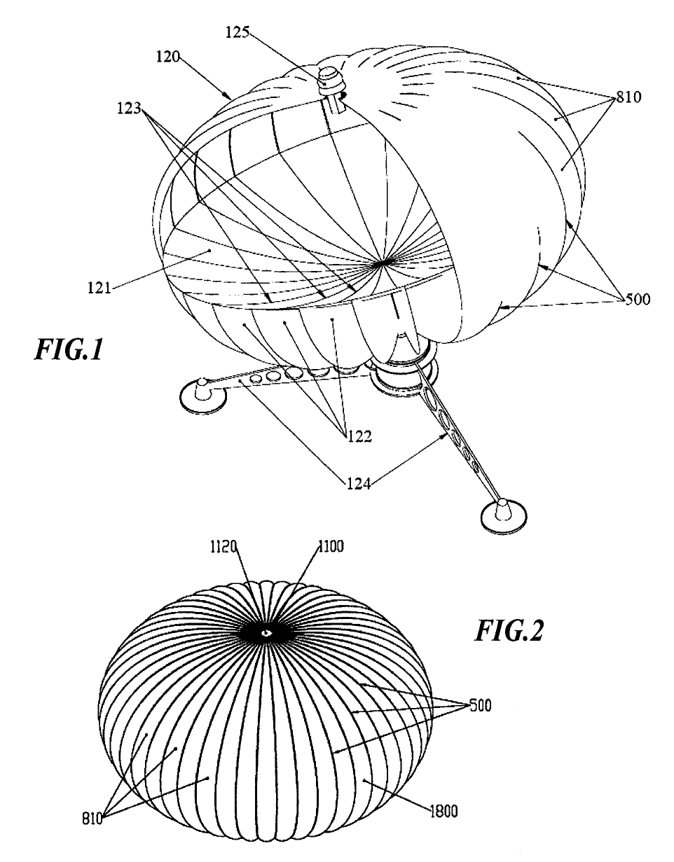

FIG. 1 is a view of an inflatable flexible vessel structure 120 providing precision support and protection for an antenna reflector 121 according to an example embodiment. The reflector 121, in an example embodiment, is itself a flexible, deployable structure contained within the vessel 120. Delivered to its operational environment in a collapsed configuration, the vessel 120, upon pressurization and distention, provides the reflector 121 with requisite geometric stability through the reflector's perimeter connection to the equator of the vessel's restraint structure. Through this equatorial connection, the reflector 121 shown in FIG. 1 takes full advantage of the maximum aperture diameter permitted by the vessel 120. Thus, equatorial connection is a convenient option if antenna requirements allow, however, since the vessel's restraint structure can provide precisely defined geometry, other connection locations may be more advantageous, again depending on requirements. The reflector 121 shown in FIG. 1 is of such parabolic dimension to permit the antenna feed 125 to be conveniently positioned at the pole of the vessel 120. If conditions allow, with adequate pressurization the aforementioned feed-positioning can be maintained without the use of a feed-supporting mast structure reducing mass and enhancing deployability.

In FIG. 1, further definition of the antenna's geometry is provided by a web of reflector-shaping load ribs 122 positioned between radial seams 123 of the reflector 121 and meridionally corresponding tendons 500 of the vessel's restraint structure. Geometry-defining components, such as the aforementioned web of load ribs 122, may be constructed from materials which rigidize in the environment in which the structure is deployed. As such, the structural geometry is safeguarded in case of depressurization of the vessel 120. Such incorporation of rigidizable materials is particularly applicable to orbital space environments whereby orbital debris may puncture the vessel 120. While the example embodiment shown in FIG. 1 is mounted upon a tripodal support structure for surface deployment, an analogous embodiment may be transported in its collapsed configuration and subsequently deployed in space. Other antenna types and more general categories of precision support requiring architecture may be supported internally or externally.

An example embodiment of the vessel 120 as shown in FIG. 1 serves as precision support for the contained antenna reflector 121 and serves as protective cover for the sensitive antenna equipment. Such integrated protection offers greater mass and volume efficiency than conventionally stationary ‘radomes’. Furthermore, the present subject matter provides predictable antenna signal interference patterns than conventional, stationary ‘radome’-type covers because the vessel 120 and antenna are highly integrated.

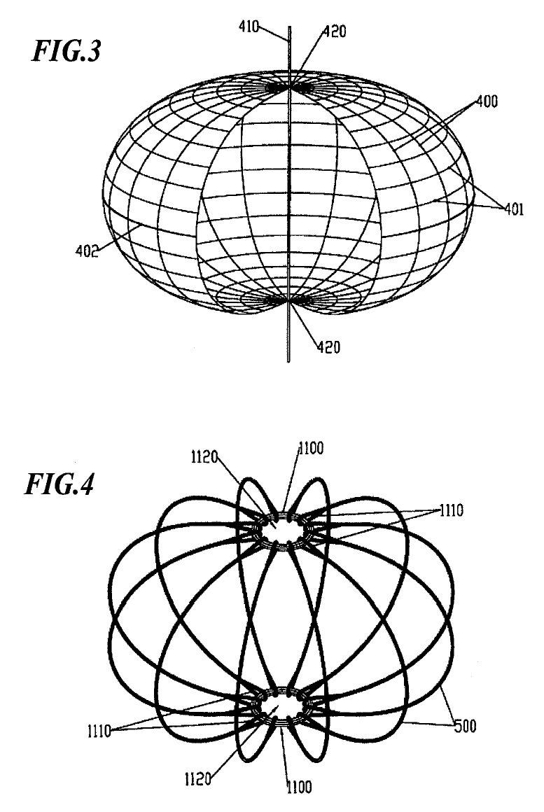

One example embodiment is described with respect to FIGS. 2-7. FIG. 3 illustrates the natural shape spheroidal geometry of one example embodiment. FIG. 3 shows meridional grid lines 400, circumferential grid lines 401 and an axis of revolution 410. The meridians 400 and circumferences 401 are perpendicular to one another; however, while the circumferences 401 are parallel to one another, the meridians 400 are non-parallel, converge at the poles 420, and achieve greatest separation at the vessel's equator 402. If the spheroidal vessel shell is disassembled along its meridians 400, the resulting pieces are three dimensional, doubly curved shell segments, which when recombined, would present the original closed shell. In the context of flexible vessels, note that meridians 400 can be used to define the edges of meridional ‘gores’ which are the two dimensional approximations of the shell segments described above. Being two dimensional, gores can be cut from planar sheets of material, and like the shell segments referred to above, subsequently can be connected edge to edge to reproduce a close facsimile of a fully closed three dimensional shell. The primary discrepancy is that the ‘manufactured’ shell is undesirably facetted between its meridians 400; however, this effect can be diminished by increasing the number of meridians 400 and the ensuing number of gores.

Considerable vessel flexibility and resilience is required to allow efficient folding and packaging of the vessel or of any architecture of which the vessel is part. To be flexible, the vessel's barrier structure wall needs to be relatively thin. In one example embodiment, the vessel's barrier structure wall is less than one-tenth its smallest radius of curvature. When such a thin-walled structure is subjected to such distributed loading as internal pressure, the predominant stresses are membrane stresses, i.e. stresses constant throughout the thickness of the wall. The internal pressure imparts stress in two principle directions: a meridional membrane stress sm acting parallel to the meridian 400, and a circumferential or hoop membrane stress s_{c} acting parallel to the circumference 401.

Simply stated, the one embodiment of the vessel as shown in FIG. 2 comprises a substantially impervious barrier membrane structure 1800 confined by a pressure restraint structure as shown in FIG. 4 consisting of a meridional array of tendons 500 disposed between and connected to a flexible end structure 1100 at each of the vessel's poles 420 (see FIG. 3). In FIGS. 5, 6 and 7 the geometric premise of the present subject matter is illustrated by considering a Mylar® balloon. In one example, a Mylar® balloon simulates the barrier structure 1800 and a method of construction thereof. As shown in FIG. 5, the Mylar® balloon is made by sealingly connecting two same size circles 600 of impervious Mylar® barrier film material to one another along their edges. For the theoretical purposes of this explanation the film material is assumed to be substantially inelastic thereby also resembling the barrier structure 1800 of the present subject matter. The Mylar® balloon is axisymmetric, i.e. it is symmetrical about the axis of rotation 410 passing through its two poles 420 (see FIG. 3) which are at the respective centers of the two circles of film 600.

Prior to inflation, the balloon's initial radius rᵢ and equatorial circumference cᵢ are defined by the radius and circumference of the Mylar® film's circular perimeter. As the balloon begins inflating, the center areas of the two circles of film 600 are pushed apart by the increasing volume of gas within the sealed membrane, resulting simultaneously in the balloon's perimeter being drawn towards the balloon's axis 410 (see FIG. 3). With the perimeter thus being drawn inwards, the balloon's circumference also becomes correspondingly shorter, forcing the film material to display increasingly conspicuous waviness 700 around its perimeter in its effort to contract its length cᵢ to match the balloon's newly reduced circumference. Radial wrinkles 710 in the circles of film material emanate from the perimeter undulations; with increasing inflation the perimeter waviness 700 becomes larger as do the radial wrinkles 710 which are now more aptly described as meridional.

The pertinent observation in the context of the present subject matter and of the Mylar® balloon is that, from the very instant that the vessel begins inflating and the film circles 600 depart from their planar form, the balloon's circumferential membrane stress s_{c} substantially disappears, leaving substantially all of the vessel's global membrane stress to be borne only in the meridional direction of the inflated membrane. The elimination of s_{c} is readily rationalized by considering that, as the balloon inflates, any circle drawn upon the surface of the Mylar® film concentric to the film's circular edge is displaced closer to the balloon's central axis 410, i.e. to a circular location of reduced circumference. This displacement presents excess film material in the circumferential sense thereby giving rise to radial wrinkles 710. These wrinkles 710 are incapable of forming in the presence of appreciable circumferential stress.

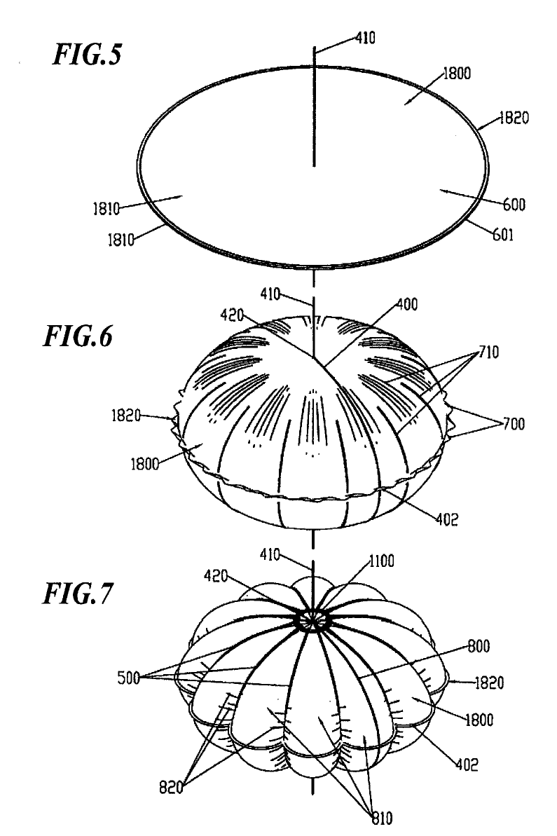

Upon full inflation the balloon does not assume the volume-to-surface area optimized shape of a sphere but rather, in the absence of circumferential membrane stress s_{c}, takes on the specific spheroidal natural shape, as shown in FIGS. 3 and 6, with an equator 402 (see FIG. 3) defined by the junction of the two constituent Mylar® film circles 600 and whereby each of the two film circles 600 has functionally deformed from an initially two dimensional planar shape to a three dimensional doubly curved hemispheroid. A cross section of the inflated balloon through its axis of rotation 410 reveals the distinctive profile curve of the balloon's natural shape where the arc length of one quadrant, i.e. one half of the length of a meridian 400, equals the radius rᵢ of the planar Mylar® film circles 600 shown in FIG. 5 and as such the length of a full meridian 400 equals 2rᵢ. The inflated balloon shown in FIG. 6 presents a final radius r_{f} and final circumference c_{f} both measured in the equatorial plane, where r_{f} is given by

$${r}_{f} = \frac{1}{\sqrt{2}} \frac{{r}_{i}}{K}$$

where K originates as an elliptic integral of the first kind in the analysis of the natural shape, presenting a value of approximately 1.8541 upon calculation, and rᵢ is the radius of the planar film portion.

As shown in FIGS. 4 and 7 a meridional array of substantially identical tendon cords 500, each of the same 2rᵢ meridional length of the inflated Mylar® balloon is now superimposed upon the inflated balloon. If subsequently the length of these tendons 500 is gradually and uniformly shortened, the array will begin to draw the balloon's surface inwards in the vicinity of the tendon paths, thereby absorbing an increasing amount of the balloon's excess meridional film material stored within the radial wrinkles 710 (as shown in FIG. 6). Because the length of the meridian described by a tendon is less than the length of the balloon's meridian 2rᵢ, circumferential wrinkles 820 to accommodate the corresponding meridional excess of film material must form in the vicinity of tendons. With continued shortening the tendons 500 increasingly restrain the balloon thereby bearing a progressively greater portion of the vessel's pressure load. The meridional dimension of the balloon remains essentially unaltered in areas not drawn inwards by the tendons 500, however as shown in FIG. 7, a configuration is ultimately encountered wherein the tendons 500 have drawn all balloon material inwards, the length of the meridian 800 of the crest of the balloon material lobes 810 between tendons 500 finally drops below 2rᵢ, and the meridional tautness along the lobe crest of the balloon film disappears. It is at this point that substantially the last of the global pressure induced stress is transferred from the balloon film material to the restraint structure.

One example embodiment presents a meridional array of tendons 500 such as described above, whereby more specifically the length of the restraint's tendons 500 is defined such that, within the application dependant range of pressures associated with the vessel's deployed configuration, the vessel's barrier structure 1800 is relieved of any meridionally oriented pressure induced load. The barrier structure 1800 is thereby permitted to substantially carry only the local hoop stress within its own bulges bridging the gap between tendons 500. Since membrane stress induced by distributed internal pressurization is proportional to the radius of membrane curvature and since the radius of the barrier bulges is small with respect to the vessel radius, the barrier is subjected to correspondingly low stress. While the restraint structure bears the global pressure confining load of the vessel, the strength requirement of the barrier structure 1800 remains independent of overall vessel size. The formation of bulging lobes 810 of barrier structure material with the introduction of the restraint structure is evidence that the global circumferential stress component remains substantially absent therefore causing the surface geometry of restraint structure to continue assuming the same natural shape, albeit of smaller scale, as the unrestrained balloon, regardless of the length of its tendons 500, and whereby the natural shape can be described as the geometry of equilibrium found when, through elimination of circumferential stress, the global pressure confining stress of the vessel is substantially carried only by the meridional tendons.

The vessel of the one embodiment as described thus far offers superlative stability, predictability and reproducibility because firstly, the vessel's natural shape geometry is obtained by default regardless of tendon 500 length and secondly, the vessel's global stress distribution is made statically determinate by directing the vessel's global pressure-induced stress to the vessel's restraint structure allowing the geometry of the surface of revolution defined by the vessel's array of tendons to be accurately predicted. This geometric predictability allows the present subject matter, upon pressurization, to be used as precision support architecture for equipment and devices requiring such precision for proper functioning. Prepared as described above, the present subject matter also presents versatility and opportunity for strength-to-weight ratio optimization by allowing tendon and the barrier structure materials, according to design drivers, to be precisely tailored to one another by juxtaposing the number of restraint tendons 500 with barrier structure lobe radius.

In one example, the meridional load carrying capacity of the barrier structure material allows the barrier structure 1800 to share a portion of the vessel's global stress with the restraint structure. While the benefit hereby is the optimized application of structural mass, the drawback is increased difficulty in precise prediction of tendon path geometry due to load partitioning between the restraint and barrier structures 1800.

The vessel developed and described in detail above and shown in FIG. 2 represents one embodiment of the vessel whereby the vessel's restraint structure comprises only a meridional array of tendons 500 disposed between and structurally connecting two flexible polar end structures 1100.

### Restraint End Structure

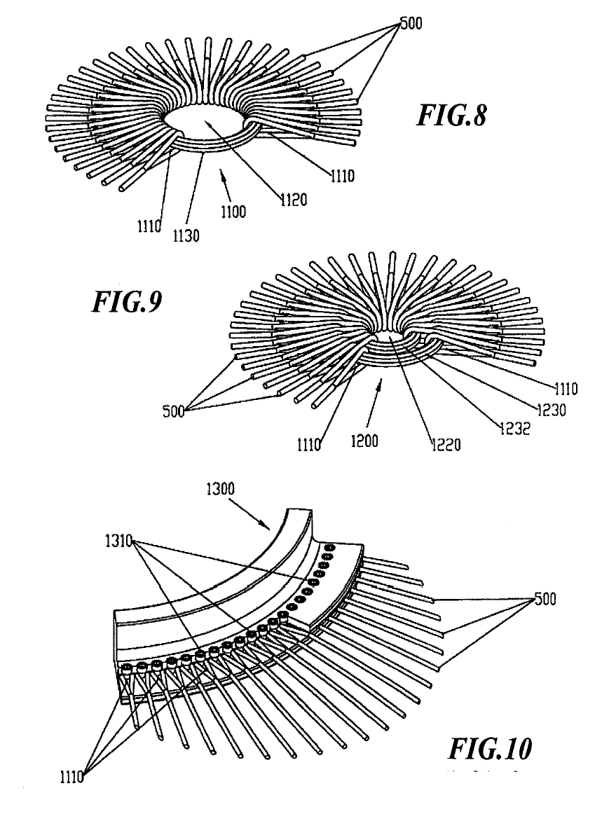

One of the challenges in forming some flexible vessels is maintaining the vessel's flexibility in polar areas where tendons 500 or other structural members or constructs converge. FIG. 4 shows an example embodiment of a vessel's restraint having flexible end structures 1100. The flexible end structures will now be discussed in further detail referring to the end structure detail views shown in FIGS. 8 and 9. An individual flexible end structure 1100 is shown in FIG. 8. The individual flexible end structure 1100 includes a piece of high modulus cordage, adequate in length to allow the cord to be threaded in several loops through the eye 1110 of one polar end of all the restraint tendons 500 to so form a ring structure 1130 of multiple strands. Depending on requirements and design priorities, a flexible end structure 1100 may alternately be constructed of cable, webbing, and the like. The tendons 500 are securely connected to the ring structure 1130 by the eye 1110 of the tendons 500. The dimensional intent in the preparation of the end structure's ring structure is to minimize the diameter of the cordage ring to preclude undue loading of the underlying barrier structure and, as such if necessary, to the extent there is only adequate space on the ring structure to accommodate the width of all the individual tendon eyes 1110 laid side by side. Despite the great loads imparted upon the ring structure in the vessel's deployed configuration, utilizing cordage of smaller diameter allows easier threading of the cord through the tendon eyes 1110, dilution of the weakness of the connection joining the two cord ends, and easier and less voluminous connection of cord ends to one another. Furthermore, depending on requirements, more than one length of cordage may be individually threaded through the aforementioned tendon eyes 1110 to so together form a ring structure benefiting from redundancy, notably in cord end connections.

The end structure 1100 describes an aperture 1120. The aperture 1120 must be sufficiently small to preclude excess loading of the underlying barrier structure 1800. The barrier structure 1800 can be reinforced in the region of the aperture 1120 to support a larger aperture 1120 if desirable, for example to accommodate larger pass throughs.

FIG. 9 illustrates an end structure 1200 having an aperture 1220. Larger vessels and higher pressure loads may result in a larger end structure aperture 1220 due to increased tendon convergence bulk so that in some embodiments it is advantageous to incorporate two or more of the aforementioned ring structures positioned concentrically to serve as a single flexible polar end structure 1200 to allow staggered attachment of tendons 500. FIG. 9 includes an outer or a first ring structure 1230 and an inner second ring structure 1232. The aperture 1220 differs from the aperture 1120 (shown in FIG. 8) in that multiple ring structures surround the aperture 1220. The aforementioned configuration of multiple concentric ring structures is especially suitable for high pressure vessels for containment of liquefied propellants and the like. The flexible end structure 1200 shown in FIG. 9 incorporates two such ring structures whereby the outer ring structure 1230 passes through all the tendon eyes 1110 of tendons 500 corresponding with and converging upon their respective pole 420 (shown in FIG. 3) of the vessel, and the inner ring structure 1232 passes through alternating eyes 1110 of the aforementioned tendons 500. Depending on requirements the outer ring structure 1230 may or may not pass through all the aforementioned tendon eyes 1110. The pattern with which tendons 500 connect to a flexible end structure 1100 comprising multiple rings can be tailored to requirements. The ring structures can also be adapted for incorporation into a system to secure the vessel to other architecture.

The vessel's restraint embodiment shown in FIG. 5 has no significant rigid components. The aforementioned embodiments provide a broad potential range of application, and provide numerous benefits such as greater compressibility and higher deployment efficiency ratio, lighter weight with resulting higher strength-to-weight ratio, greater resistance to handling, packaging and deployment trauma, and reduced cost.

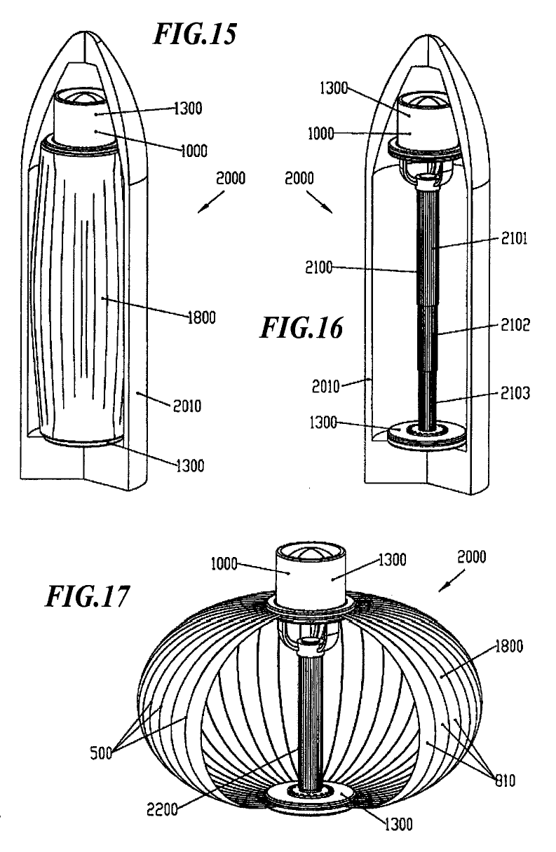

FIG. 10 shows an example embodiment of a vessel's restraint incorporating a rigid end structure 1300. Some applications require a vessel with one or more rigid components. Vessel designs providing alternative embodiments not only incorporate, but rely upon, large rigid polar end structures 1300. The embodiments of the vessel shown in FIGS. 15 and 17 incorporate a rigid end structure 1300 at one or both vessel poles 420 (shown in FIG. 3), to which the vessel's tendons 500 are structurally attached by connection devices such as bolts 1310 (shown in FIG. 10), clevises, shackles, karabiners and the like. If required the tendon eyes 1110 may alternately be spliced directly to a suitably accommodating rigid end structure 1300 thereby eliminating the need for separate fastening devices, or alternately, the end structure 1100 of a flexible end structure embodiment of the present vessel may be prepared with an adequately large aperture 1120 to allow its fitment to a suitably accommodating rigid mating structure.

### Restraint Tendons

Depending on requirements and design priorities, the vessel of the present subject matter's restraint components may be constructed of cordage, cable, webbing, and the like. Due to its relatively higher strength-to-weight ratio, cordage can be used for the restraint tendon material. In one example, the fiber products used in the restraint structure are manufactured of high modulus, high tenacity variety fibers such as Vectran®, PBO, and Technora® The fiber product Technora® is available from Teijin Limited of Japan. Other high modulus, high tenacity fiber products can be used, as well as a combination of different high modulus, high tenacity fiber types together in an individual fiber based restraint component. Besides dimensional stability, operational requirements are satisfied by a fiber type including fiber attributes such as temperature sensitivity, abrasion resistance, flex fatigue resistance, chemical and radiation sensitivity and creep.

In one example, single braid cordage construction is used. Single braid construction is prepared without a protective woven sheath, as opposed to double braid construction whereby the cordage is prepared with a protective woven sheath, typically at time of manufacture. Without the weight of the sheath single braids offer lower weight than corresponding double braids of same strength. In instances where protective covering for the cordage is essential, flexible light weight polymer coatings of considerable variety are commonly available. Other coatings or tubular sleeves may be appropriate fitted onto the tendon 500 to provide, for example, a smoother or larger diameter tendon bearing surface to reduce bearing surface trauma to the vessel's distended barrier structure 1800.

In one embodiment, the meridional restraint tendons 500 are prepared from cordage furnished with a spliced eye 1110 at both ends which allow the tendon's structural connection to the vessel's respective polar end structures. In the example embodiment of the restraint tendon 500, the tendon's eyes 1110 can be prepared in advance of the tendon's integration to so help facilitate modular assembly of the vessel. Alternately the eye 1110 can be spliced directly to a flexible end structure 1100 or rigid end structure thereby eliminating connection fittings.

The tendons 500 of the vessel's restraint structure must be prepared in such a way to enable their precise connection to the underlying barrier structure 1800 for positional indexing purposes. Accurate physical indexing of vessel components preserves intended load pathways and is suited for materials having high modulus fibers. The indexing connection allows modular assembly of components and is of sufficient strength to maintain integrity throughout manufacturing and application.

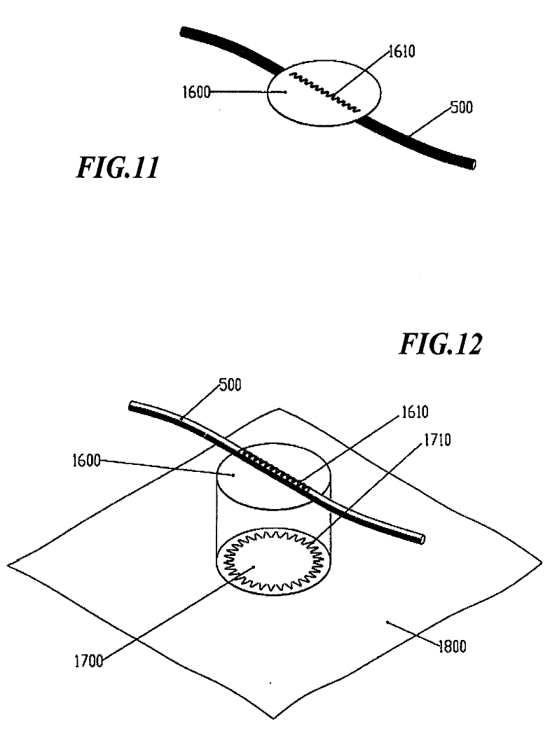

FIG. 11 is an isometric detail view of an indexing tab fastened to a restraint tendon. FIG. 12 is an isometric detail view of a method for locally fastening a restraint tendon to the vessel's barrier structure 1800 according to an example embodiment. Now referring to both FIGS. 11 and 12, the relationship between the indexing tab, the restraint tendon and the barrier structure will be further detailed. As shown in FIG. 11 a mating half of a fastening device 1600 is attached to the tendon 500 with sewn stitches 1610 at requirement specified intervals whereby, at time of vessel assembly, the aforementioned tendon fastening device can be structurally mated to the corresponding mating half 1700 of a like fastening device attached with sewn stitches 1710 to the surface of the barrier structure 1800 as shown in FIGS. 12, 13 and 14. It should be noted that there are a great number of potential fastening devices available. In one embodiment, the fastening devices include adhesive pads, heat-activated bonding pads, and hook-and-loop fasteners. In circumstances not requiring modular assembly, especially in smaller vessel construction, it may prove more efficient to directly attach tendons 500 to the barrier structure 1800 with intermittent or continuous stitching, or by another alternate method. Another method to fasten straps and cordage to fabric items is by passing the tendon 500 through a sleeve affixed to the fabric surface. This method is employed in the restraint tendon 500 to barrier structure 1800 connection to keep the tendon 500 captive over a substantial portion of the length of the tendon to reduce chance of fouling upon deployment. In the context of the present subject matter, the tendon 500 may be indexed to the material of the sleeve mentioned above, or to the barrier structure 1800 surface where the sleeve is discontinuous, by employing a fastening device of a type mentioned earlier.

The circumferential wrinkles 820 of barrier structure material in the vicinity of restraint tendons 500 which accommodate the meridional excess of barrier material arising from the discrepancy in meridional length between tendons and barrier structure 1800 provides latitude in the geometric indexing of barrier structure 1800 to the restraint structure. In one example, the aforementioned latitude provides increased tolerance for material and manufacturing imperfections, benefits manufacturing and the integration processes, and provides resilience with respect to tight and imperfect packaging, different packaging configurations, and imperfect deployment sequences.

### Barrier Structure

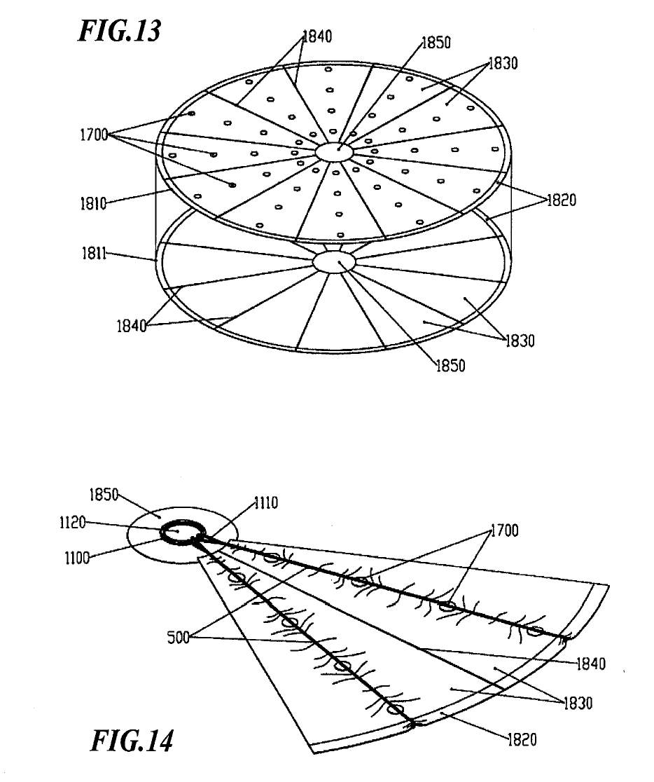

FIG. 13 is a simplified perspective view of two component circles, 1810 and 1811, of barrier structure material prepared for assembly of the vessel's barrier structure 1800 according to an example embodiment. FIG. 14 is a view of two restraint tendons 500 fastened to the vessel's barrier structure 1800 according to an example embodiment. Now referring to both FIGS. 13 and 14, construction of the barrier structure will be further detailed. The vessel's barrier structure 1800 contains the gaseous or liquid fluids within its envelope. Solid objects may be comprised within the fluid contained within the barrier structure 1800. The barrier structure 1800 may comprise one or more structural carrier layers confining one or more substantially impervious bladder layers, or the barrier structure 1800 may comprise only one bladder layer, or several bladder layers. Carrier layer(s) and bladder layer(s) may also be conveniently combined in a single laminate to reduce assembly complexity. For convenience hereinafter bladder and carrier are each referred to in singular with the understanding that, depending on the context or unless otherwise noted, ‘bladder’ refers to single or multiple bladders and ‘carrier’ refers to single or multiple carriers.

The primary function of the carrier component of the barrier structure 1800 is to structurally envelop the impervious bladder component of the barrier structure 1800 thereby maintaining the elongation of the bladder material below a threshold of diminished impermeability. An example embodiment has the structural integrity of the carrier being dependent only upon its load bearing function for the short spans between restraint tendons 500, and independent of the overall size of the vessel. As described earlier in detail, the vessel's restraint tendons 500 can be calibrated to avoid meridional loading of the carrier structure. In one example, to improve strength-to-weight ratio, the carrier is prepared from an unbalanced fabric weave of high tenacity, high modulus fiber whereby the high strength direction of the carrier fabric, featuring low elongation, less crimped fibers, is oriented perpendicular to the restraint tendons 500. The aforementioned weave types are found in many types of sailcloth and frequently enhanced with a further directional reinforcement of high-modulus fibers. Mutual indexing of segregated barrier and carrier layers is possible using the fastening methods described earlier (see ‘Restraint Tendons’). The term ‘barrier structure material’ is a term of convenience referring to the collection of carrier and bladder layers comprised by the wall of the barrier structure 1800.

As shown in FIG. 13 an example embodiment of the vessel's barrier structure 1800 is prepared by sealingly connecting two substantially planar circles, 1810 and 1811, of barrier structure material to one another along their edges 1820 thereby offering the advantages and performance characteristics explained in detail above in the context of the Mylar® balloon. If separate carrier and bladder shell layers are to be used in construction of the barrier structure 1800, many assembly options are available. For example: After initial preparation of two separate circles each of both carrier and barrier materials, the bladder is made substantially impervious by sealing the bladder circle edges together, after which the carrier circles may be indexed to their respective sides of the bladder to be subsequently closed around their edges thereby enveloping the bladder. For most applications, the required diameter of the circular barrier material components will exceed the manufactured width of the source materials thereby requiring the circles to be fabricated of a plurality of pie-shaped gores 1830 which allow material characteristics to be more homogenously maintained throughout the vessel's lobes. When connected to one another, the aforementioned gores 1830 form a substantially planar circle whereby the gore connection seams 1840 form a radial pattern emanating from the circle's center. The circle center corresponds to the deployed vessel's poles 420 (shown in FIG. 3) and the circle's radial gore connection seams forms a pattern of meridional seams when the vessel is deployed. Especially if the barrier material is substantially isotropic in nature, it may be possible to prepare the barrier structure 1800 in the most material-efficient manner possible, i.e. by cutting the barrier structure 1800 circles from full-widths of barrier material joined edge-to-edge.

As shown in FIGS. 13 and 14 the tips of the pie-shaped barrier structure gores 1830 converge upon the vessel's pole 420 (shown in FIG. 3) and are there connected to a circle of barrier structure material known as the ‘top cap’ 1850 to avoid the convergence of gore connection seams to a single point. The top cap 1850 may be reinforced to accommodate the pressure induced load resulting from large end structure apertures 1120 and 1220. In the case that the present subject matter includes one or more rigid polar end structures 1300 which further include a pass through opening in their structure, the barrier bladder will be sealingly attached to the rigid end structure 1300 employing sealing and gasketting methods.

A planar barrier structure presents significant benefits, primarily for vessel assembly and integration, some of which are: The calculational aspects of design are simplified throughout vessel development; planar components are easier to prepare and join; easier assembly leads to homogeneity of construction, enhanced precision, reproducibility, and greater average strength; quality control is easier to perform; and incorporation of local modifications, especially those for increased strength and reinforcement, is simplified.

In the same fashion used to assemble most balloon type structures, an alternate embodiment of the vessel's barrier structure 1800 is constructed of a plurality of conventional meridional gores of the type described earlier in the discussion of FIG. 3 and employing the methods of construction described above. In a further embodiment of the aforementioned vessel's meridional gore barrier structure, the pattern of gore connection seams is offset from the pattern of meridional tendons 500 thereby preserving greater vessel flexibility by avoiding the confluence of material and the stiffness associated with seams.

### Internal Core

Some applications favor the incorporation of an internal structural core. FIGS. 15-17 show a vessel 2000 that includes a flexible barrier structure 1800, and an extendable core 2100 positioned between a pair of rigid end structures 1300. FIG. 15 is a cut-away view of the vessel with rigid polar end structures 1300 and telescopic core in its collapsed configuration positioned within a launch vehicle payload fairing 2010. FIG. 16 is a cut-away view of the vessel shown in FIG. 15 with the flexible barrier portion removed to more clearly show the vessel's end structures and telescopic core 2100 when in the collapsed configuration. FIG. 17 shows the vessel 2000 in its deployed configuration. The core 2100 is disposed lengthwise between and connected to the two polar end structures. The core 2100 includes a first telescopic component 2101, a second telescopic component 2102, and a third telescopic component 2103. It should be noted that other embodiments may have a telescopic core with a different number of telescopic components, or a rigid, non-telescopic core. FIG. 17 shows the core 2100 when deployed. The core 2100 shown in FIG. 17 corresponds to the distended, deployed configuration of the vessel's flexible barrier portion. The extended core 2100, as shown in FIG. 16, pushes the end structures apart allowing the shell to collapse and align itself with the core. By varying the pressure within the telescopic core, considerable control of both packaging and deployment can be achieved, especially when the aforementioned core pressure is varied in concert with the pressure within the vessel. The global geometric shape of the deployed vessel can also be axially modified by varying the length the core 2100.

Further benefits of a structural core are dependent upon application of the vessel but may include structural integrity for transport packaging, to safeguard against rocket launch-induced stress, or housing for services and controls. In the case of an antenna reflector contained within the interior of the present subject matter, the core may function as support mast for the antenna's feed hardware. An internal core is not required for packaging of the structure of the present subject matter. Depending on requirements, the present subject matter can be packaged by rolling or folding of the geometry presented by the planar barrier structure 1800 embodiment.

### ADDITIONAL EXAMPLES

The present subject matter is suitable as support or protection for antennas, reflectors, sensors, telescope optics, solar power collection or transmitting antennas, radomes, etc. A vessel according to present subject matter can provide the aforementioned support or protection by being applied as lighter-than-air craft. The aforementioned applications involve integration of the present subject matter with other architecture and comprise the attachment of accessories to the vessel whereby such attachment is readily accomplished with suitable fastening devices and methods. Other example embodiments are also contemplated. Example embodiments include internal fastenings to allow attachment of internal structures such as partitions, protective bladder liners and bulkheads; structural adaptations and exterior fastenings permitting the present subject matter to be connected to or incorporated into other architecture.

Although various embodiments have been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense.

The foregoing description of the specific embodiments reveals the general nature of the technology sufficiently that others can, by applying current knowledge, readily modify and/or adapt it for various applications without departing from the generic concept, and therefore such adaptations and modifications are intended to be comprehended within the meaning and range of equivalents of the disclosed embodiments. It is to be understood that the phraseology or terminology employed herein is for the purpose of description and not of limitation. Accordingly, the present subject matter embraces all such alternatives, modifications, equivalents and variations as fall within the spirit and broad scope of the appended claims.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising:
a restraint structure having a plurality of meridional tendons;
an inelastic envelope within the restraint structure, the restraint structure configured to confine the envelope, wherein the envelope is inflatable and wherein, when inflated, the envelope sustains a load in a direction parallel with an equator of the envelope and the restraint structure sustains a load in a direction parallel with the meridional tendons; and
at least one anchor point affixed to the restraint structure.

2. The apparatus of claim 1 wherein the at least one anchor point includes a telescopic core.

3. The apparatus of claim 1 wherein the at least one anchor point is affixed to a meridional tendon.

4. The apparatus of claim 1 wherein the at least one anchor point includes an antenna mount.

5. An apparatus comprising:
a vessel having an inflatable barrier structure and a restraint structure configured to confine the barrier structure, the restraint structure including a plurality of meridional tendons terminating at a pole; and
when inflated, the barrier structure sustains a load in a direction parallel with an equator of the barrier structure and the restraint structure sustains a load in a direction parallel with the meridional tendons.

6. The apparatus of claim 5 wherein the restraint structure further includes a ring at the pole.

7. The apparatus of claim 6 wherein the ring is affixed to a rigid mating structure.

8. The apparatus of claim 6 wherein a portion of at least one meridional tendon is configured to pass through an aperture of the ring.

9. The apparatus of claim 6 wherein a portion of at least one meridional tendon is affixed to the ring by at least one of a bolt, a clevis, a shackle, and karabiner.

10. The apparatus of claim 6 wherein at least one meridional tendon includes an eye having a portion looped through an aperture of the ring.

11. The apparatus of claim 6 wherein an aperture of the ring is configured to accommodate the plurality of meridional tendons.

12. The apparatus of claim 6 wherein the barrier structure includes a reinforcement proximate an aperture of the ring.

13. The apparatus of claim 5 wherein the restraint structure includes a plurality of concentrically aligned rings at the pole.

14. The apparatus of claim 13 wherein a first meridional tendon is affixed to a first concentrically aligned ring and a second meridional tendon is affixed to a second concentrically aligned ring.

15. The apparatus of claim 5 wherein at least one meridional tendon is coated.

16. The apparatus of claim 5 wherein at least one meridional tendon passes through a tubular sleeve.

17. The apparatus of claim 5 wherein a portion of at least one meridional tendon includes a spliced eye.

18. The apparatus of claim 5 wherein at least one meridional tendon includes at least one of a cord, a cable, and webbing.

19. The apparatus of claim 5 further including a solar power collection unit coupled to the restraint structure.

20. An apparatus comprising:
a vessel having an inflatable barrier structure and a restraint structure configured to confine the barrier structure, wherein the barrier structure is inflatable and wherein, when inflated, the barrier structure sustains a load in a direction parallel with an equator of the envelope and the restraint structure includes a plurality of meridional tendons and sustains a load in a direction parallel with the meridional tendons; and
an antenna structure within the vessel.

21. The apparatus of claim 20 wherein the vessel includes a pole position and further including an antenna feed disposed at the pole position.

22. The apparatus of claim 20 wherein at least one tendon terminates at the pole.

23. The apparatus of claim 20 wherein the vessel has an equator and wherein the antenna structure is affixed to the equator.

24. The apparatus of claim 20 wherein the vessel has an equator and wherein the antenna structure is affixed at a location in a plane parallel to the equator.

25. The apparatus of claim 20 wherein the barrier structure includes a plurality of two dimensional gores.

26. The apparatus of claim 20 wherein the antenna structure includes a plurality of radial load ribs.

27. The apparatus of claim 20 wherein the vessel is collapsed in a first environment and deployed in a second environment, and wherein a load rib includes a material which rigidizes in the second environment.

28. The apparatus of claim 20 wherein the inflatable vessel has more than one radius of curvature and a wall thickness of the barrier structure is less than one-tenth of a smallest radius of curvature.

29. The apparatus of claim 20 wherein the barrier structure includes two planar circles bonded at an edge.
